(19) United States
(12) Patent Application Publication
(10) Pub. No.: US 2013/0279496 A1
(43) Pub. Date: Oct. 24, 2013

(54) COMMUNICATION APPARATUS AND A COMMUNICATION PROTOCOL SWITCHING METHOD

(71) Applicant: KABUSHIKI KAISHA TOSHIBA, Tokyo (JP)

(72) Inventors: Akira Takahashi, Tokorozawa-shi (JP); Tomozo Murayama, Hachioji-shi (JP); Koichi Masuda, Higashimurayama-shi (JP); Tomoaki Tokunaga, Ome-shi (JP)

(73) Assignee: KABUSHIKI KAISHA TOSHIBA, Tokyo (JP)

(21) Appl. No.: 13/773,183

(22) Filed: Feb. 21, 2013

(30) Foreign Application Priority Data
Apr. 24, 2012 (JP) 2012-099181

(51) Int. Cl. H04L 29/06

(52) U.S. Cl. CPC H04L 69/08
USPC 370/352

(57) ABSTRACT

According to one embodiment, an communication apparatus includes a processor and a controller. The processor receives a communication signal from the communication ports or the communication network, and executes communication processing based on a first program corresponding to a communication protocol of a communication port being connected. The controller switches from the first program set in the processor to a second program corresponding to a communication protocol different from that of the first program, based on a predetermined condition.

### CROSS-REFERENCE TO RELATED APPLICATIONS

This application is based upon and claims the benefit of priority from Japanese Patent Application No. 2012-099181, filed Apr. 24, 2012, the entire contents of which are incorporated herein by reference.

### FIELD

Embodiments described herein relate generally to a communication apparatus used, for example, as an Internet Protocol (IP) telephone, and a communication protocol switching method.

### BACKGROUND

In recent years, IP telephone systems are in wide use, wherein image and sound in the form of packet data are transmitted and received in real time and bi-directionally through a Local Area Network (LAN) or an Internet Protocol (IP) network such as the Internet. Needless to say, the IP telephone systems enable sound communications between IP telephone terminals connected to an IP network and between IP telephone terminals and telephone terminals connected to a public network.

An IP telephone terminal has two LAN ports. One of the ports is connected to the LAN, and telephone calls are enabled by this port. The other port is connected, in many cases, to a personal computer, and a relay function is provided thereby. As a result, only one LAN cable is required for connection between an Internet access point and a device on an office desk.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic illustration showing an IP telephone system according to the first embodiment.

FIG. 2 is a schematic illustration showing an IP telephone terminal according to the first embodiment.

FIG. 3 is a flowchart illustrating the control procedures of an IP telephone terminal used when communication protocols are switched from one to another in the first embodiment.

FIG. 4 is a flowchart illustrating the control procedures of the IP telephone terminal used when a LAN port is reconnected in a second embodiment.

FIG. 5 is a flowchart illustrating the control procedures of an IP telephone terminal used when a LAN port is disconnected in a third embodiment.

### DETAILED DESCRIPTION

Various embodiments will be described hereinafter with reference to the accompanying drawings. In general, according to one embodiment, an communication apparatus includes a processor and a controller. The processor receives a communication signal from the communication ports or the communication network, and executes communication processing based on a first program corresponding to a communication protocol of a communication port being connected. The controller switches from the first program set in the processor to a second program corresponding to a communication protocol different from that of the first program, based on a predetermined condition.

### First Embodiment

The first embodiment is configured to switch to a low-speed communication mode when no communication apparatus is connected to a communication port or the communication apparatus connected to that communication port does not require high-speed communication.

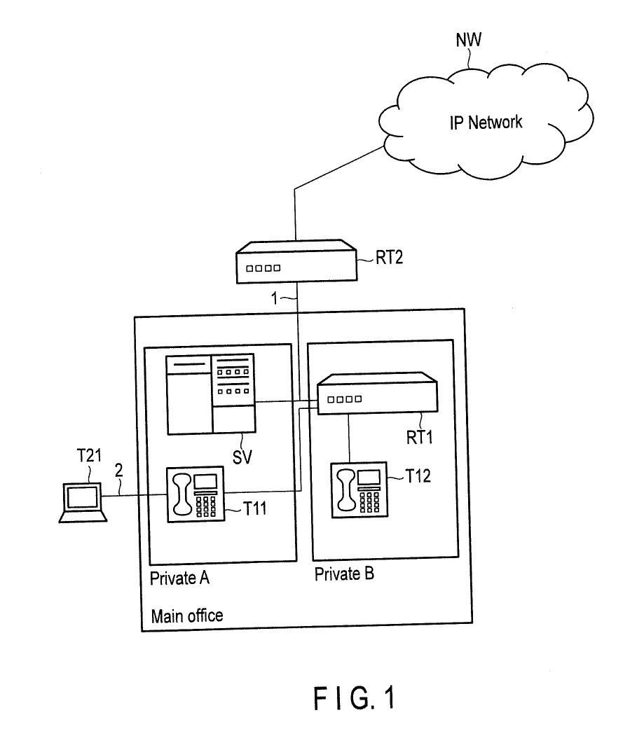

FIG. 1 is a schematic illustration showing an IP telephone system according to the first embodiment.

The system comprises a Local Area Network (LAN) 1 in a main office. A call control server SV, a hub RT1 (serving as a feed device) and a router RT2 are connected to the LAN 1. IP telephone terminals T11 and T12, serving as communication apparatuses, are connected to the hub RT1. The hub RT1 checks the identity of the IP telephone terminals T11 and T12 for authentication, and supplies power to the IP telephone terminals T11 and T12 based on the results of authentication.

The IP telephone terminals T11 and T12 are terminals having a call processing function and a media information processing function.

The router RT2 connects the LAN1 to an IP network NW, such as the Internet. The call control server SV has an exchange control function wherein a session is established between the IP telephone terminals T11 and T12 or between these IP telephone terminals and IP telephone terminals on the IP network NW based on SIP, for example. After the session is established, the call control server SV performs sound communications based on the peer-to-peer connection between a calling telephone terminal and a called telephone terminal.

The IP telephone terminal T11 has a data relay function. For example, a communication terminal T21, such as a personal computer, can be connected to the IP telephone terminal T11 through a LAN port 2. In FIG. 1, the relay function of the IP telephone terminal T11 uses only one LAN port, but two or more LAN ports may be used. In other words, a plurality of communication terminals T21 can be connected to the IP telephone terminal T11.

In the first embodiment, it is assumed that the communication terminal T21 requires faster communications than the IP telephone terminal T11, and the communication standard which the communication speed of the communication terminal T21 has to satisfy is different from that which the communication speed of the IP telephone terminal T11. The IP telephone terminal T11 is used mainly for sound communications, and the use of Fast Ethernet (registered trademark) is sufficient. When the communication terminal T21 is connected, however, there may be a case where Giga Ethernet (registered trademark) is required. To deal with such a situation, the communications between the IP telephone terminal T11 and the LAN 1 are made compatible with a high-speed communication mode (Giga Ethernet), and are set in the high-speed communication mode at all times, irrespective of the connection state of the communication terminal T21. That is, the communications require a large consumption power.

In the first embodiment, in order to solve the problems of the large consumption power arising from the high-speed communications, the communications between the IP telephone terminal T11 and the LAN 1 are switched in accordance with the connection state (connected/disconnected state) of the communication terminal T21. To be more specific, the high-speed communication mode is set only when the communication terminal T21 is connected. When the communication terminal T21 is not connected, the communication mode is switched to the low-speed mode, and the power consumption is reduced.

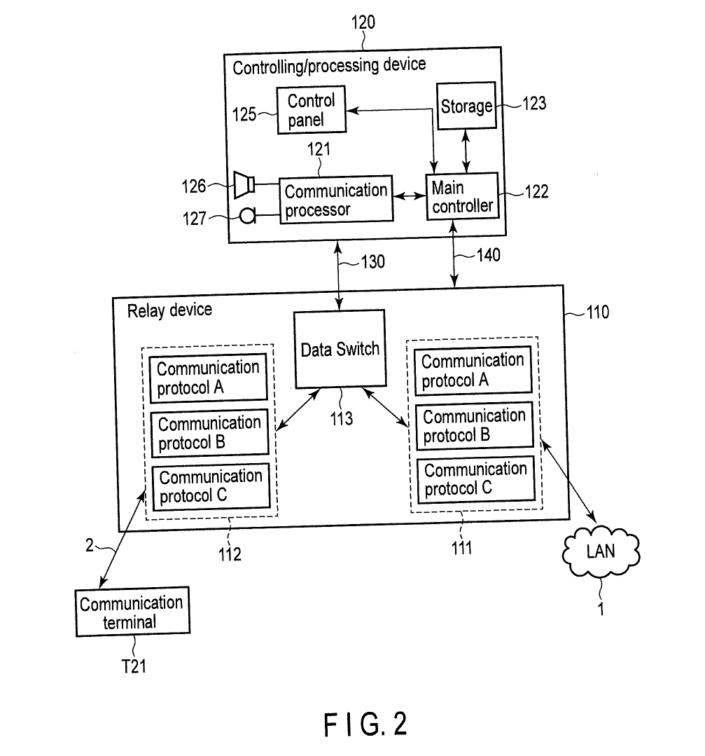

According to the first embodiment, the IP telephone terminal T11 has the function described below. FIG. 2 is a block diagram illustrating the configuration of the function.

In FIG. 2, the IP telephone terminal T11 comprises a relay device 110 and a controlling/processing device 120. The relay device 110 and the controlling/processing device 120 are connected together through a data highway 130 and a control highway 140. It is assumed that the data highway 130 is compatible with Fast Ethernet (registered trademark).

The relay device 110 comprises protocol processors 111 and 112, and a data switch 113. Protocol processor 111 is connected to the LAN 1 and processes IP packets received from the LAN 1 or IP packets to be transmitted to the LAN 1, based on the program corresponding to the communication protocol set by the controlling/processing device 120. When the communication protocol corresponding to Giga Ethernet (registered trademark) is set for the communications between the LAN 1 and the IP telephone terminal T11, protocol translation is performed between the communication protocol of the data highway 130 and the communication protocol corresponding to the Giga Ethernet (registered trademark), in order to permit the IP packets of the LAN 1 to be exchanged through the data highway 130. This protocol translation enables the LAN 1 to be connected directly to the data highway 130.

Protocol processor 111 extracts a communication signal and a control signal, for example, from an IP packet sent through the LAN 1. Protocol processor 111 supplies the communication signal to the controlling/processing device 120 through the data switch 113 and the data highway 130, and supplies the control signal to the controlling/processing device 120 through the control highway 140. In addition, protocol processor 111 subjects serial data supplied from the controlling/processing device 120 to time-division multiplex to generate an IP packet for transmission, and supplies the generated IP packet to the LAN 1.

Protocol processor 112 is connected to the LAN port 2, and exchanges data with the communication terminal T21 based on the program corresponding to the communication protocol set by the controlling/processing device 120.

The data switch 113 selectively switches to the connection between protocol processor 111 and the data highway 130 or to the connection between protocol processor 111 and protocol processor 112, based on a control command of the controlling/processing device 120.

The controlling/processing device 120 comprises a communication processor 121, a main controller 122, a storage 123 and a control panel 125. The communication processor 121 extracts telephone conversation data from a communication data supplied from the relay device 110, and reproduces a reception analog sound signal from the communication data. The communication processor 121 drives a handset telephone receiver 126 in response to the reproduction of the reception sound signal and outputs the reception sound signal.

An analog transmission sound signal generated by a handset telephone transmitter 127 is supplied to the communication processor 121. The communication processor 121 converts the transmission sound signal into a communication signal of predetermined format, and supplies the communication signal to the relay device 110 through the data highway 130.

The main controller 122 comprises a CPU, a ROM, a RAM, etc., and controls each portion of the IP telephone terminal T11 based on software processing. The storage stores programs corresponding to communication protocols A, B and C.

The control panel 125 comprises a display such as a Liquid Crystal Display (LCD), and a key input section. The display displays various kinds of information output from the main controller 122 and representing the operation state of the terminal, telephone directory, etc.

The main controller 122 of the first embodiment has a function of detecting whether the LAN port 2 is connected by transmitting a control signal to the relay device 110 and receiving a return signal from the relay device 110 at predetermined intervals. When the connection of the LAN port 2 is detected, the main controller 122 reads a program of communication protocol A corresponding to Giga Ethernet (registered trademark) from the storage 123 and sets the program in the protocol processors 111 and 112 of the relay device 110. When the connection of the LAN port 2 is disconnected from the IP telephone terminal T11, the main controller 122 or when the communication terminal T21 does not require communication protocol A corresponding to Giga Ethernet (registered trademark), the main controller 122 updates the program set in the protocol processors 111 and 112 and uses, for example, a program of communication protocol C corresponding to Fast Ethernet (registered trademark).

A description will now be given of the operation performed by the above configuration.

(Data Communications Performed by Communication Terminal T21)

A description will be given of the case where the communication terminal T21 connected to the LAN port 2 performs data communications using the LAN 1.

Let us assume that a user operates the communication terminal T21 to execute data communications with a desired communication party through the LAN 1. In response to the operation, the communication terminal T21 transmits a connect message to the IP telephone terminal T1 based on communication protocol A corresponding to Giga Ethernet (registered trademark).

The connect message is received by protocol processor 112 of the relay device 110 by way of the LAN port 2. Upon receipt of the connect message, the protocol processor 112 executes the procedures for establishing the communication connection with the other-party terminal connected to the LAN 1. In the procedures for establishing the communication connection, the IP telephone terminal T11 transmits the connect message to the other-party terminal of the LAN 1 based on communication protocol A corresponding to Giga Ethernet (registered trademark). In this manner, the communication connection is established between the communication terminal T21 and the other-partner terminal on the LAN 1. Thereafter, data communications are enabled between the communication terminal T21 and the other-party terminal, through the LAN port 2, the IP telephone terminal T11 and the LAN 1.

(Switching of Communication Protocol)

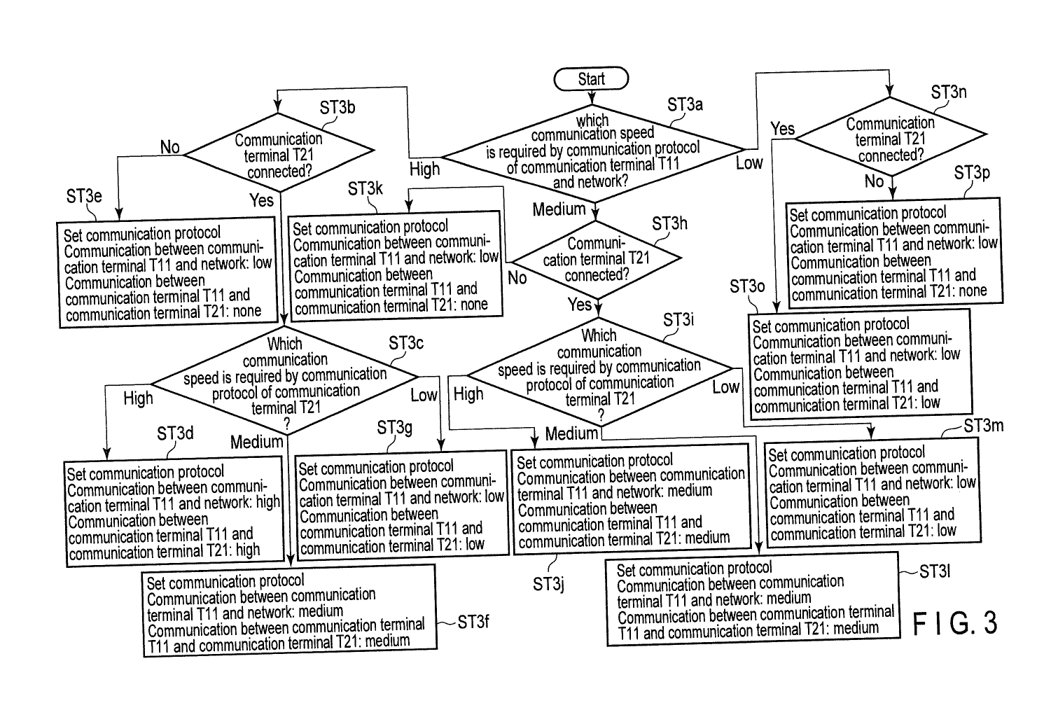

FIG. 3 is a flowchart illustrating the control procedures of the main controller 122 used when communication protocols are switched from one to another.

Let us assume that the communication terminal T21 is performing data communications with the other party-terminal on the LAN 1. Since communication protocol A corresponding to Giga Ethernet (registered trademark) is set in the protocol processors 111 and 112, the main controller 122 proceeds from block ST3a to block ST3b and determines whether the communication terminal T21 is connected to the LAN port 2. Since the communication terminal T21 is connected (Yes) in this case, the main controller 122 determines the communication speed of the communication protocol required by the communication terminal T21 (block ST3c). Since communication protocol A is used in this case, the main controller 122 controls the protocol processors 111 and 112 to maintain the state of communication protocol A (block ST3d).

When it is determined in block ST3b that the LAN port 2 is disconnected from the IP telephone terminal T11 (No), the main controller 122 reads a program of communication protocol C corresponding to Fast Ethernet (registered trademark) from the storage 123, and sets the read program in protocol processor 111. As a result, communication protocol A switches to communication protocol C (block ST3e).

When the user sets the communication speed of the communication terminal T21 to be communication protocol B, the main controller 122 detects communication protocol B by the negotiation with the communication terminal T21, reads a program of communication protocol B from the storage 123, and sets the program in the protocol processors 111 and 112 (block ST3f). When the user uses sets the communication speed of the communication terminal T21 to be communication protocol C, the main controller 122 reads a program of communication protocol C from the storage 123, and sets the program in the protocol processors 111 and 112 (block ST3g).

It is assumed that a LAN port requesting communication protocol B is connected to the IP telephone terminal T11. Since, in this case, communication protocol B is set in the protocol processors 111 and 112, the main controller 122 proceeds from block ST3a to block ST3h and determines whether a communication terminal is connected to the LAN port. Since the communication terminal is connected to the LAN port (Yes), the main controller 122 determines the communication speed of the communication protocol required by the communication terminal (block ST3i). Even if communication protocol A is required by the communication terminal, the main controller 122 controls the protocol processors 111 and 112 to maintain the state of communication protocol B (block ST3j).

If it is determined in block ST3h that the LAN port 2 is disconnected from the IP telephone terminal T11 (No), the main controller 122 reads a program of communication protocol C corresponding to Fast Ethernet (registered trademark) from the storage 123, and sets the read program in protocol processor 111. As a result, communication protocol B switches to communication protocol C (block ST3k).

Even if the user sets the communication speed of the communication terminal to be communication protocol B, the main controller 122 controls the protocol processors 111 and 112 to maintain the state of communication protocol B (block ST3l). When the user sets the communication speed of the communication terminal to be communication protocol C, the main controller 122 reads a program of communication protocol C from the storage 123 and sets the read program in the protocol processors 111 and 112 (block ST3m).

Let us assume that a LAN port requesting communication protocol C is connected to the IP telephone terminal T11. Since, in this case, communication protocol C is set in the protocol processors 111 and 112, the main controller 122 proceeds from block ST3a to block ST3n and determines whether a communication terminal is connected to the LAN port. If the communication terminal is connected to the LAN port (Yes), the main controller 122 controls the protocol processors 111 and 112 to maintain the state of communication protocol C (block ST3n).

When it is determined in block ST3n that the LAN port 2 is disconnected from the IP telephone terminal T11 (No), the main controller 122 controls protocol processor 111 to maintain the state of communication protocol C (block ST3p).

As described above, according to the first embodiment, a program corresponding to communication protocol A of high communication speed is set in the protocols 111 and 112 only when necessary, as in the case where the LAN port 2 is connected to the IP telephone terminal T11. When the LAN port 2 is not connected, or when the communication speed required by the communication terminal T21 connected to the LAN port 2 is low, the program set in the protocol processors 111 and 112 is switched to a program corresponding to communication protocol C of low communication speed. As a result, the power consumption of the IP telephone terminal T11 can be reduced.

Even where the LAN port 2 is connected to the IP telephone terminal T11, there may be a case where the communication speed required by the communication terminal T21 connected to the LAN port 2 is low. In such a case, communication protocol A can be replaced with communication protocol C for the communications between the LAN 1 and the IP telephone terminal T11. If this is done, the power consumption by the entire IP telephone terminal T11 can be reduced.

Furthermore, according to the first embodiment, if it is determined that the LAN port 2 is not connected to the IP telephone terminal T11, the program set in the protocol processors 111 and 112 is changed to a program corresponding to communication protocol C of data highway 130. As a result, the IP telephone terminal T11 can execute sound communications, which are a minimum kind of communications.

### Second Embodiment

The second embodiment is configured to determine whether the communication termination time generated by the reconnection between a communication port and a communication network is permissible when the communication is connected again. If the communication termination time is not permissible, the second embodiment is configured to wait for the communication termination time to become permissible, and to change the program to be set in a processor to a program compatible with a communication protocol of the communication port connected again.

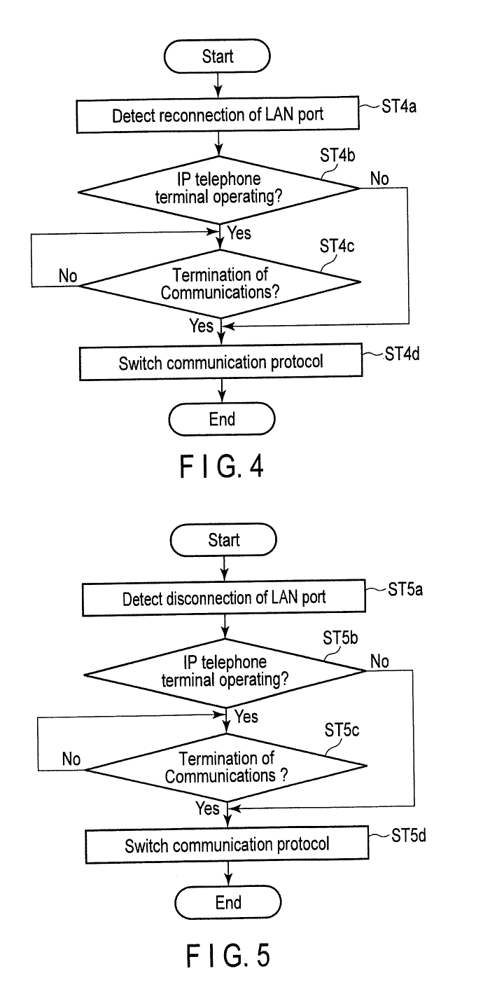

FIG. 4 is a flowchart illustrating the control procedures a main controller 122 performs when a LAN port is reconnected in the second embodiment.

Let us assume that a communication terminal T21 is connected when an IP telephone terminal T11 is operating in the state where the communication terminal T21 is not connected to the IP telephone terminal T11. In this case, the IP telephone terminal T11 has to switch to a high-speed communication protocol for communications with a LAN 1.

The controller 122 detects reconnection of the LAN port 2 (block ST4a) and determines whether the IP telephone terminal T11 is in communication (block ST4b). When the IP telephone terminal 11 is in communication (Yes), the main controller 122 determines whether or not the communication terminates (block ST4c). When the communication terminates (Yes), the main controller 122 switches communication protocol C, which is set in protocol processors 111 and 112, to communication protocol A (block ST4d).

On the other hand, if the IP telephone terminal T11 is in a standby state (No) in block ST4b, the main controller 122 switches from communication protocol C, which is set in the protocol processors 111 and 112, to communication protocol A.

If the termination time generated when a controlling/processing device 120 has its communication port disconnected or reconnected is permissible, then the main controller 122 carries out switching. If the termination time is not permissible, the main controller 122 waits for the termination time to become permissible, and then carries out switching.

In the IP telephone terminal T11 described above, the disconnection/reconnection of a communication port is required for the switching between Fast Ethernet (registered trademark) and Giga Ethernet (registered trademark). When the IP telephone terminal T11 is in communication, the disconnection/reconnection of a communication port should not be performed because the disconnection/reconnection of the communication port generates a communication termination time, resulting in the disconnection of the line. In this case, therefore, the switching of a communication protocol is executed after the termination of the call.

According to the second embodiment described above, when the LAN port 2 of the IP telephone terminal T11 is connected again, a determination is made, prior to the switching of a communication protocol, as to whether the communication termination time generated by the reconnection between the LAN port 2 and the LAN 1 is permissible. If the communication termination time is not permissible, it is waited to become permissible. After the communication termination time becomes permissible, the program set in the protocol processors 111 and 112 is changed to a program compatible with the communication protocol of the LAN port 2 connected again.

Therefore, the communication protocols can be switched from one to another without disconnection of a call. Hence, communication protocols can be switched from one to another with enhanced reliability.

### Third Embodiment

The third embodiment is configured to determine whether the communication termination time generated by the disconnection of a communication port from a communication network is permissible when the communication port is disconnected. If the communication termination time is not permissible, a main controller 112 waits for the communication termination time to become permissible. After the communication termination time becomes permissible, the program set in protocol processors 111 and 112 is changed to a program corresponding to a communication protocol of a speed lower than the communication speed of a communication port.

FIG. 5 is a flowchart illustrating the control procedures the main controller 122 performs when a LAN port is disconnected in the third embodiment.

Let us assume that a communication terminal T21 is disconnected when an IP telephone terminal T11 is operating in the state where the communication terminal T21 is connected to the IP telephone terminal T11. In this case, the IP telephone terminal T11 has to switch to a low-speed communication protocol for communications with a LAN 1.

The main controller 122 detects the disconnection of the LAN port 2 (block ST5a) and determines whether the IP telephone terminal T11 is in communication (block ST5b). When the IP telephone terminal 11 is in communication (Yes), the main controller 122 determines whether or not the communication terminates (block ST5c). When the communication terminates (Yes), the main controller 122 switches from communication protocol A, which is set in protocol processors 111 and 112, to communication protocol C (block ST5d).

If the IP telephone terminal T11 is in a standby state (No) in block ST5b, the main controller 122 switches from communication protocol A set in the protocol processors 111 and 112 to communication protocol C.

If the termination time generated when a controlling/processing device 120 has its communication port disconnected or reconnected is permissible, then the main controller 122 carries out switching. If the termination time is not permissible, the main controller 122 waits for the termination time to become permissible, and then carries out switching.

In order for the above-mentioned IP telephone terminal T11 to switch between Fast Ethernet (registered trademark) and Giga Ethernet (registered trademark), the communication port has to be disconnected or reconnected. When the IP telephone terminal T11 is in communication, the disconnection/reconnection of a communication port should not be performed because the disconnection/reconnection of the communication port generates a communication termination time, resulting in the disconnection of the line. In this case, therefore, the switching of a communication protocol is executed after the termination of the call.

According to the third embodiment described above, when the LAN port 2 of the IP telephone terminal T11 is disconnected, a determination is made, prior to the switching of a communication protocol, as to whether the communication termination time generated by the disconnection of the LAN port 2 from the LAN 1 is permissible. If the communication termination time is not permissible, the main controller 122 waits for the communication termination time to become permissible. After the communication termination time becomes permissible, the program set in protocol processor 111 is changed to a program corresponding to communication protocol C of a speed lower than the communication speed of a LAN port.

Therefore, the communication protocols can be switched from one to another without disconnection of a call. Hence, communication protocols can be switched from one to another with enhanced reliability.

### Other Embodiments

In the embodiments described above, the program set in the protocol processors is switched to another in response to the detection of a state where a LAN port is not connected or a state where a communication terminal is set for low-speed communication. However, the program switching may be executed based on other conditions, such as predetermined times of the day.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An communication apparatus being connected to a communication network and comprising a plurality of communication ports, wherein the communication ports comprise different communication speeds for signals and are selectively connected to the communication network, the communication apparatus comprising:
a processor configured to receive a communication signal from the communication ports or the communication network, and to execute communication processing based on a first program corresponding to a communication protocol of a communication port being connected; and
a controller configured to switch from the first program set in the processor to a second program corresponding to a communication protocol different from that of the first program, based on a predetermined condition.

2. The communication apparatus of claim 1, wherein the controller checks a connection state of the communication port as the predetermined condition, and switches from the first program set in the processor to the second program corresponding to a communication protocol of a communication speed lower than a communication speed of the communication port if the communication port is not determined as being connected.

3. The communication apparatus of claim 2, wherein
if the processor and the controller are connected by a data communication path of a lower communication speed than that of the communication port,
the controller switches from the first program set in the processor to the second program corresponding to the communication protocol of the data communication path, if the communication port is determined as not being connected.

4. The communication apparatus of claim 1, wherein the controller determines whether a communication termination time generated by reconnection between the communication port and the communication network is permissible when the communication port is reconnected, and switches from the first program set in the processor to the second program corresponding to the communication protocol of a reconnected communication port after waiting for the communication termination time to become permissible.

5. The communication apparatus of claim 1, wherein the controller determines whether a communication termination time generated by disconnection of the communication port from the communication network is permissible when the communication port is disconnected, and switches from the first program set in the processor to the second program corresponding to the communication protocol of a speed lower than the communication speed of the communication port after waiting for the communication termination time to become permissible.

6. The communication apparatus of claim 1, wherein the controller detects, as the predetermined condition, a condition where a communication speed required by a communication device connected to the communication port is lower than a communication speed of the communication port, and switches from the first program set in the processor to the second program corresponding to a communication protocol of a communication speed lower than that of the communication port.

7. A communication protocol switching method for use in a communication apparatus configured to be connected to a communication network and comprising a plurality of communication ports, wherein the communication ports comprise different communication speeds for signals and are selectively connected to the communication network, the method comprising:
setting a first program corresponding to a communication protocol of a communication port to a processor, when the communication port is connected;
supplying a communication signal from the communication port or the communication network to the processor, and causing the processor to execute communication processing based on the first program; and
switching from the first program set in the processor to a second program of a different communication protocol from that of the first program, based on a predetermined condition.

8. The method of claim 7, wherein the switching comprises checking a connection state of the communication port as the predetermined condition, and switching from the first program set in the processor to the second program corresponding to a communication protocol of a communication speed lower than a communication speed of the communication port if the communication port is not determined as being connected.

9. The method of claim 8, wherein
if connection to the processor is made by a data communication path of a lower communication speed than that of the communication port,
the switching comprises switching from the first program set in the processor to the second program corresponding to the communication protocol of the data communication path, if the communication port is determined as not being connected.

10. The method of claim 7, wherein the switching comprises: determining whether a communication termination time generated by reconnection between the communication port and the communication network is permissible when the communication port is reconnected; and switching from the first program set in the processor to the second program corresponding to the communication protocol of a reconnected communication port after waiting for the communication termination time to become permissible.

11. The method of claim 7, wherein the switching comprises: determining whether a communication termination time generated by disconnection of the communication port from the communication network is permissible when the communication port is disconnected; and switching from the first program set in the processor to the second program corresponding to the communication protocol of a speed lower than the communication speed of the communication port after waiting for the communication termination time to become permissible.

12. The method of claim 7, wherein the switching comprises: detecting, as the predetermined condition, a condition where a communication speed required by a communication device connected to the communication port is lower than a communication speed of the communication port, and switching from the first program set in the processor to the second program corresponding to a communication protocol of a communication speed lower than that of the communication port.
